(19) United States
(12) Patent Application Publication
(10) Pub. No.: US 2026/0083146 A1
(43) Pub. Date: Mar. 26, 2026

(54) EDIBLE LIPID ELEMENT, METHOD OF PREPARATION AND USES THEREOF

(71) Applicant: Redefine Meat Ltd., Rehovot (IL)

(72) Inventors: Yael PRIGAT GOLDFRIEND, Tel Aviv (IL); Moran COHEN, Be'er Ya'akov (IL); Daniel DIKOVSKY, Ariel (IL)

(21) Appl. No.: 19/135,123

(22) PCT Filed: Dec. 5, 2023
(86) PCT No.: PCT/IL2023/051243

§ 371 Date: Jun. 3, 2025

Related U.S. Application Data
(60) Provisional application No. 63/536,550, filed on Sep. 5, 2023.

(30) Foreign Application Priority Data
Dec. 5, 2022 (IL) 298839

(51) Int. Cl. A23D 7/005; A23D 7/02; A23J 3/22; A23J 3/26

(52) U.S. Cl. CPC A23D 7/0053; A23D 7/02; A23J 3/227; A23J 3/26

(57) ABSTRACT

The present disclosure provides a lipid element and alternative food products comprising the same. The lipid element comprises an edible lipid element comprising a hydrocolloid having dispersed within the hydrocolloid lipid material, said lipid material being solid or semi-solid at least at a temperature of 10° C. An example of an alternative food product that comprises the disclosed lipid element is, for example, an alternative whole muscle cut meat, where the lipid element is combined with a protein containing component. Also disclosed are methods of producing the disclosed lipid elements and of producing the alternative food products.

### TECHNOLOGICAL FIELD

The presently disclosed subject matter relates to the food industry and in particular to the alternative food industry, specifically, the alternative meat industry.

### BACKGROUND ART

References considered to be relevant as background to the presently disclosed subject matter are listed below:
Hanula, M.; Szpicer, A.; Górska-Horczyczak, E.; Khachatryan, G.; Pogorzelska-Nowicka, E.; Poltorak, A. Quality of Beef Burgers Formulated with Fat Substitute in a Form of Freeze-Dried Hydrogel Enriched with Açai Oil. Molecules 2022, 27, 3700. https://doi.org/10.3390/molecules27123700
International Patent Application Publication No. WO21229027
International Patent Application Publication No. WO10133609
International Patent Application Publication No. WO05115341
International Patent Application Publication No. WO08002995
US Patent Application Publication No. US20220330573.

Acknowledgement of the above references herein is not to be inferred as meaning that these are in any way relevant to the patentability of the presently disclosed subject matter.

### BACKGROUND

Lipids in general, and specifically fats are an essential component in food and its incorporation into non-animal derived food alternatives is challenging.

Hanula at al. describes the use of lyophilized hydrogels formulated with konjac flour and sodium alginate and enriched with encapsulated acai oil and its successfully application as a fat substitute in beef burgers.

WO21229027 describes a bacon replacement food product comprising at least one layer of a composition comprising water, oil and a hydrocolloid and at least one coat layer comprising a plant protein containing composition. The composition is preferably stable at heat, i.e. does not melt under heating.

WO08002995 describes an indulgent edible composition that provides an orally pleasurable eating experience similar to chocolate as the chocolate melts in the oral cavity. The composition comprises (a) a starch; (b) a protein-containing component; (c) a sweetener; (d) a fat-containing component that melts at a temperature of about 45° C. or less; (e) a hydrocolloid gelling agent that facilitates the formation of a gel matrix that will break down at a temperature of about 45° C. or less; and (f) an edible surfactant.

The combination of hydrogels or hydrocolloids with oil has also been described in the pharmaceutical industry, particularly for the delivery of water insoluble active ingredients.

WO^{o} 133609 describes compositions comprising a water-soluble polymer matrix in which are distributed droplets of oil, the composition comprising an active principle. The oil droplets are substantially immobilized in or by the matrix and the immobilizing feature is lost as the matrix dissolves in aqueous media.

WO05115341 describes microbeads containing oil-associated biologically active compounds and methods for their manufacture and use. The microbeads consist of a soluble complex of non-digestible polymer and emulsifier with oil-associated biologically active compounds embedded in a matrix of digestible polymer.

Finally, US20220330573 describes meat analogs using hydrocolloid gels or films as structural components of meat analog food products. The hydrocolloid is formed by setting of oil-in hydrocolloid emulsions, where the oil is entrapped as spherical droplets in the hydrocolloid gel matrix.

### GENERAL DESCRIPTION

In accordance with a first aspect of the presently disclosed subject matter there is provided a lipid element comprising a hydrocolloid having dispersed therein lipid material, the lipid material being solid or semi-solid at least at a temperature of 10° C.

In accordance with a second aspect of the presently disclosed subject matter there is provided a food product comprising one or more lipid elements, each lipid element comprising a hydrocolloid having dispersed therein lipid material, the lipid material being solid or semi-solid, at least at a temperature of 10° C.

The food product is preferably a whole cut meat alternative, where the lipid element is in combination with at least a protein containing component.

In accordance with a third aspect of the presently disclosed subject matter there is provided a method of producing a lipid element, the method comprises mixing lipid material that is solid or semi solid at least at a temperature of 10° C., with a hydrocolloid forming aqueous solution comprising a hydrocolloid forming agent to form a mixture;
wherein, said mixing is at a temperature by which said lipid material is solid or semi solid; and
wherein said mixing produces/allows for the formation of a continuous hydrocolloid matrix having, dispersed therein, said lipid material.

It is to be noted that a unique feature of the present disclosure resides in the combination of the hydrocolloid forming material (in the form of an aqueous solution) with the lipid material being in solid particulate form. In other words, the mixing of the two components excludes mixing of the lipid in fluid or liquid form. As such, no lipid droplet is or can be formed during this mixing. The solid (e.g. powder) state of the lipid element results in the entrapment of lipid bodies that are not lipid droplets.

Without being bound by theory, it is believed that the dispersion of the lipid as entrapped lipid bodies within a continuous hydrocolloid matrix, as opposed to the lipid material forming the continuous phase, improves the fat-associated texture of the lipid element and the final products including it, inter alia, the chewiness.

Further, without being bound by theory, it is believed that the use of solid or semi solid lipid material during the “entrapment” within the matrix, allows for entrapment of higher amounts of lipid within the matrix, while maintaining the lipid material as the dispersed phase (i.e. not turning it into the continuous phase).

The method comprises, in accordance with some preferred examples, the mixing of the lipid material with the hydrocolloid aqueous solution, when the lipid material is in solid form, e.g. particulate or powder form.

Further, in some preferred examples, the lipid element dispersed in the hydrocolloid has irregular shape and/or is essentially not spherical.

In accordance with a fourth aspect of the presently disclosed subject matter there is provided a method of producing a whole cut meat analogue, the method comprising dispensing a plurality of stacked layers, each layer comprising essentially aligned protein strands, wherein at least part of the plurality of layers includes intermittently dispensed lipid elements disclosed herein, said lipid elements being dispensed according to a predefined pattern.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a graph showing Storage Modulus of coconut oil alone, beef tallow, beef fat tissue and of two repeated measurements (FT1 and FT2) of an alginate-cocoa butter containing lipid element according to a non-limiting example (Example 1) of the presently disclosed subject matter.

FIGS. 2A-2B are graphs showing the compression strength (MPa) at 25° C. (-) and 50° C. (-------) of 3 repeated measurements of beef fat (FIG. 2A), and of an alginate-cocoa butter containing lipid element according to a first non-limiting example of the presently disclosed subject matter (FIG. 2B).

FIGS. 3A-3D are microscope images of lipid elements comprising a dispersion of cocoa butter bodies in Ca-alginate matrix (FIG. 3A), a dispersion of cocoa butter bodies in methyl cellulose (FIG. 3B), or comparison emulsions of coconut oil in agar-agar (FIG. 3C) or of canola oil spherical droplets in methyl cellulose (FIG. 3D).

FIGS. 4A-4C are images of strands of alginate-cocoa butter containing lipid element according to non-limiting Example 1 of the presently disclosed subject matter (FIG. 4A), of an alternative whole muscle cut produced with an alginate-cocoa butter containing lipid element according to non-limiting Example 4 of the presently disclosed subject matter, before cooking (FIG. 4B) and after cooking at 165° C. for 12 minutes (FIG. 4C).

FIG. 5 is an image of an alternative whole muscle cut produced by 3D printing according to non-limiting Example 5, using a first nozzle for extruding protein containing component/protein mass (protein mass identified by the full arrow ->) and a second nozzle for extruding methyl cellulose cocoa butter lipid element (lipid element identified by the broken arrow - - - ->) according to non limiting Example 2A.

FIG. 6 is an image of an alternative whole muscle cut produced by 3D printing according to non-limiting Example 6, using a first nozzle for extruding protein containing component/protein mass (protein mass identified by the full arrow ->) and a second nozzle for extruding methyl cellulose cocoa butter lipid element (lipid element identified by the broken arrow ---->) according to non limiting Example 2B.

### DETAILED DESCRIPTION

The present disclosure is based on the development of fat alternatives for use in the food industry. Specifically, it has been envisaged by the inventors of the present invention that there is a need to provide alternatives for fat portions within animal-free food products, such as in alternative meat slabs or steaks. To this end, lipid containing elements that are solid at room temperature have been developed.

Specifically, and in accordance with a first aspect of the presently disclosed subject matter, there is provided a lipid element comprising a hydrocolloid matrix having dispersed therein lipid material, the lipid material being solid or semi solid at least at a temperature of 10° C. The combination of the hydrocolloid and the lipid material can be considered as a solid dispersion comprising the continuous hydrocolloid matrix and dispersed therein visually distinct solid or semi solid bodies of the lipid material.

In the context of the present disclosure when referring to a lipid element it is to be understood to encompass any solid body comprising a hydrocolloid matrix entrapping, as a dispersion, the lipid material, the later being, solid or semi solid at least at a temperature of 10° C.

In the context of the present disclosure, when referring to a matrix it is to be understood to refer to a scaffold or any other spatial structure formed from the hydrocolloid forming agent that is suitable for encasing/entrapping or otherwise holding the bodies of lipid material, the lipid material being in its solid or semi-solid state, at least at 10° C.

In the context of the present disclosure, when referring to a solid or semi solid state, or to a solid or semi-solid lipid material it is to be understood to refer to any physical state other than liquid or gas states. In addition, or alternatively, the term solid or semi-solid denotes a state at which the lipid does not or cannot leak out of the matrix, at least at 10° C.

In the context of the present disclosure, the term hydrocolloid agent denotes one or more substances that together form, in the presence of water, a gel matrix.

In some examples of the presently disclosed subject matter, the hydrocolloid forming agent is selected from the group consisting of cellulose, methylcellulose, hydroxypropyl methylcellulose, pectin (including HM-Pectin that forms a gel under acidic conditions in the presence of high sugar concentrations and LM-Pectin that forms a gel by interaction with divalent cations, particularly Ca2+Chen, Jun, et al. “Pectin modifications: a review.” Critical reviews in food science and nutrition 55.12 (2015): 1684-1698.) agar-agar, carrageenan, gum arabic, gellan gum, locust bean gum, guar gum, xanthan gum, maltodextrin, gum ghatti, tara gum, gum karaya, gum tragacanth, dextran, konjac flour, aribinogalactan, furcellaran, alginate and alginate derivatives (suitable for forming edible hydrocolloids), propylene glycol alginate, glucomannan, inulin, curdlan, gum acacia and fractionated portions and mixtures thereof.

In some examples of the presently disclosed subject matter, the hydrocolloid forming agent is a hydrocolloid forming agent that forms into a gel by cross-linking. A non-limiting example for a cross linkable hydrocolloid forming agent is alginate, cross linkable with a divalent cation, e.g. calcium.

In some other examples of the presently disclosed subject matter, the hydrocolloid forming agent is a hydrocolloid forming agent that forms into a gel by heating. In this context it is to be understood that the formation of a gel from this type of hydrocolloid forming agents may begin also before significant heating (e.g. to 50° C.), by applying shear forces (that inherently cause some degree of heating). Yet, a desirable gel will be created upon active heating (e.g. cooking). A non-limiting example of a hydrocolloid forming agent that forms into a stiff gel by heating is methyl cellulose (MC).

It is noted that the melting temperature of a lipid in the lipid material can be either known in the art or can be determined for example, by, Wiley mp (AOCS Method Cc 2-38), open capillary slip point, softening point (AOCS method Cc 3-25), Mettler dropping point or ASTM D5440-17.

For example, incipient melting of cocoa butter takes place between 31.2° C. and 32.7° C. and complete melting occurs between 32° C. and 34° C.

In some examples of the presently disclosed subject matter, the hydrocolloid forming agent that forms into a gel by cross linking is selected from the group consisting of alginate (in the presence of an ion), gellan (low acyl, in the presence of an ion), Konjac (in the presence of high/basic pH).

In some examples of the presently disclosed subject matter, the hydrocolloid forming agent that forms into a hard/stiff gel by heating is selected from the group consisting of methylcellulose, gellan (high acyl), curdlan.

In some examples of the presently disclosed subject matter, the hydrocolloid forming agent comprises any combination of two or more of the herein described hydrocolloid agents.

In some examples of the presently disclosed subject matter, the hydrocolloid forming agent comprises at least Gellan.

In some examples of the presently disclosed subject matter, the hydrocolloid forming agent comprises at least Konjac.

In some examples of the presently disclosed subject matter, the hydrocolloid forming agent comprises at least Alginate.

In some examples of the presently disclosed subject matter, the hydrocolloid forming agent comprises at least methyl cellulose (MC).

As noted above, in some examples of the presently disclosed subject matter, the hydrocolloid forming agent forms or at least starts forming a matrix once brough in contact with water. In some cases of the presently disclosed subject matter, such hydrocolloids can be regarded as activated material. For example, when methyl cellulose is mixed, under high shear (vigorous) mixing conditions, with water, it is referred to as activated methyl cellulose. To complete the gelling process, the activated MC is preferably actively heated.

In some examples of the presently disclosed subject matter, a hydrocolloid forming agent requires the presence of a cross linking agent (cross linker) in order to form a hydrocolloid matrix. In some examples of these cases, the hydrocolloid comprises an edible cross-linking agent that together with the hydrocolloid forming agent forms said gel matrix.

In some examples of the presently disclosed subject matter, the cross-linking agent is a cross-linking cation.

In some examples of the presently disclosed subject matter, the cross-linking cation is a divalent or multivalent cross-linking cation.

In some examples of the presently disclosed subject matter, the cross-linking cation is selected from the group consisting of calcium, potassium, sodium, magnesium.

In view of the above, it is to be understood that when the gel matrix is formed by cross-linking the hydrocolloid comprises in addition to the hydrocolloid forming agent the edible salt with which it cross links to form the gel matrix.

In some examples of the presently disclosed subject matter, the edible cross-linking salt is or comprises inorganic or organic salts, these include, without being limited thereto, calcium chloride, calcium oxide, calcium lactate, calcium citrate, calcium malate, sodium chloride, sodium lactate, sodium citrate, potassium chloride, iodine chloride, magnesium oxide, magnesium chloride, or any other edible alkali or alkaline earth metal containing salt.

In some examples of the presently disclosed subject matter, the edible cross-linking salt in the lipid element is in an amount of between 0 wt % and 3 wt %, i.e. either in an undetectable amount (i.e. comprising 0%) or in a detectable amount that does not exceed a weight amount of 3%.

In some examples of the presently disclosed subject matter, the amount of the edible cross-linking salt, if present in the lipid element, is between 0.01% and 5%; at times, between 0.01% and 2%; at times, between 0.05% and 3%; at times, between 0.05% and 2%; at times, between 0.1% and 3%; at times, between 0.1% and 2%; at times, between 0.5% and 3%; at times, between 0.1% and 2%. The amount of the edible salt can be at any range between 0.01% and 3%, even if not explicitly and literally disclosed herein.

The amount of the hydrocolloid forming agent can be defined out of the total weight of the hydrocolloid component of the lipid element (i.e. the element excluding the lipid material); or out of the total weigh of the lipid element, i.e. including the hydrocolloid portion and the lipid material, the latter constituting at least about 50 wt % out of the total element, as defined below.

In some examples of the presently disclosed subject matter, the hydrocolloid forming agent is present in the lipid element in an amount equal or up to 15 wt % out of a total weight of the hydrocolloid component; at times, in an amount of up to 13 wt %; at times, in an amount equal or up to 11 wt %; at times, in an amount equal or up to 9 wt %; at times, in an amount equal or up to 7 wt %.

In some examples of the presently disclosed subject matter, the hydrocolloid forming agent is present in the hydrocolloid portion of the lipid element in an amount of at least 0.25 wt % out of a total weight of the hydrocolloid portion; at times, in an amount of at least 1 wt %; at times, in an amount of at least 0.1 wt %; at times, in an amount equal or at least 2 wt %.

In some examples of the presently disclosed subject matter, the hydrocolloid forming material is present in the hydrocolloid portion in an amount of between about 0.25 wt % and about 15 wt %; at times, in an amount between about 1 wt % and about 12 wt %; at times, between about 1.25 wt % and about 10 wt %; at times, between about 1.5 wt % and about 10 wt %; at times, between about 1.0 wt % and about 7 wt %; at times, between about 1.0 wt % and about 6 wt %; at times, between about 0.5 wt % and about 10 wt %; at times, between about 0.5 wt % and about 8 wt %; at times, between about 2 wt % and about 5 wt %.

Any range within the above ranges, even if not explicitly and literally stated, forms part of the presently disclosed subject matter.

In some examples of the presently disclosed subject matter, the hydrocolloid forming agent is present in the lipid element in an amount equal or up to 8.0% out of a total weight of the lipid element (the lipid material constituting at least about 50% as detailed below); at times, in an amount equal or up to 7.5%; at times, in an amount equal or up to 7.0%; at times, in an amount equal or up to 6.5%; at times, in an amount equal or up to 6.0%; at times, in an amount equal or up to 5.5%; at times, in an amount equal or up to 4.0%; at times, in an amount equal or up to 3.5%; at times, in an amount equal or up to 3.0%; at times, in an amount equal or up to 2.5%.

In some examples of the presently disclosed subject matter, the hydrocolloid forming agent is present in the lipid element in an amount of at least about 0.1% out of a total weight of the lipid element (the lipid material constituting at least about 50% as detailed below); at times, in an amount of at least about 0.5%; at times, in an amount of at least about 1.0%; at times, in an amount of at least about 1.25%; at times, in an amount of at least about 1.5%.

In some examples of the presently disclosed subject matter, the hydrocolloid forming material is present in the lipid element in an amount of between about 0.1 wt % and about 8.0 wt %; at times, in an amount between about 0.1 wt % and about 7 wt %; at times, between about 0.25 wt % and about 6.0 wt %; at times, between about 0.5 wt % and about 5.0 wt %; at times, between about 1.0 wt % and about 4.0 wt %; at times, between about 1.0 wt % and about 3 wt %; at times, between about 0.5 wt % and about 3 wt %; at times, between about 0.5 wt % and about 8 wt %; at times, between about 1.0 wt % and about 2.5 wt %.

Any range within the above ranges, even if not explicitly and literally stated, forms part of the presently disclosed subject matter.

The lipid material in the lipid element is or comprises one or more edible lipid.

In some examples of the presently disclosed subject matter, the lipid material comprises one or more edible lipids that in combination are solid or semi solid at least at a temperature of 10° C.

When the lipid material includes a single lipid, the single lipid is solid or semi solid at least at a temperature of 10° C.

In some examples, when the lipid material includes two or more different edible lipids, the combination of the lipids provides a lipid material that is solid or semi solid at least at a temperature of 10° C. In other words, the lipid material is solid or semi-solid at least at 10° C., irrespective of the number of different edible lipids included therein.

In some examples of the presently disclosed subject matter, the lipid material is solid or semi-solid at a temperature below 50° C.

In some examples of the presently disclosed subject matter, the lipid material has a melting point or softening point at a temperature above 10° C. and below about 50° C.

In some examples of the presently disclosed subject matter, the lipid material is solid at a temperature between 15° C. and 40° C.; or between 10° C. and 35° C.; or between 5° C. and 30° C.

In some examples of the presently disclosed subject matter, the lipid material is semi-solid at a temperature between 15° C. and 40° C.; or between 10° C. and 35° C.; or between 5° C. and 30° C.; or between 30° C. and 40° C.; or between 25° C. and 35° C., each range constituting an independent embodiment of the presently disclosed subject matter.

In some examples of the presently disclosed subject matter, the lipid material (or the one or more edible lipids) within the lipid element constitutes at least 30% out of a total weight of the lipid element.

In some examples of the presently disclosed subject matter, the lipid material within the lipid element constitutes at least 40% out of a total weight of the lipid element.

In some examples of the presently disclosed subject matter, the lipid material within the lipid element constitutes at least 50% out of a total weight of the lipid element.

In some examples of the presently disclosed subject matter, the lipid material within the lipid element constitutes up to 90% out of a total weight of the lipid element; at times, up to 85 wt %; at times, up to 80 wt % out of a total weight of the lipid element.

In some examples of the presently disclosed subject matter, the lipid material within the lipid element constitutes between 30 wt % and 90 wt % out of a total weight of the lipid element; at times, between 35 wt % and 90 wt %; at times, between 40 wt % and 90 wt %; at times, between 50 wt % and 90 wt %; at times, between 55 wt % and 90 wt %; at times, between 60 wt % and 90 wt %; at times, between 60 wt % and 85 wt %; out of a total weight of the lipid element.

In some examples of the presently disclosed subject matter, the hydrocolloid forming agent is a cross-linkable hydrocolloid forming agent, e.g. alginate, and the lipid within the lipid element constitutes at least 50% out of a total weight of the lipid element.

In some examples of the presently disclosed subject matter, the lipid element comprises additives that do not significantly affect the texture properties of the element. Without being limited thereto, the edible additives may include colorants, flavoring agents and flavoring enhancing agents.

The lipid material within the lipid element is present, at least at 10° C., in a form of distinct lipid bodies dispersed within the hydrocolloid matrix.

In the context of the presently disclosed subject matter, when referring to lipid bodies dispersed with a matrix or to a dispersion per se, it is to be understood to be distinct/different from an emulsion (i.e. not an emulsion). Thus, when referring a hydrogel or hydrocolloid product including oil droplets (liquid or solid at 10° C.), it is to be understood to mean a product formed from an oil in water emulsion; and when referring to a hydrogel or hydrocolloid lipid element including lipid bodies that are solid or semi solid at 10° C., it is to be understood to mean a product that is obtained from solid or semi solid particles (e.g. powder) of the lipid that is dispersed in the hydrogel or hydrocolloid forming media in solid or semi solid state. At least one immediate result of this mode of formation is that the particles essentially maintain an irregular shape in the resulting product, and at least the majority thereof do not have a spherical or essentially spherical shape throughout the product. In other words, while some particles may have a general spherical appearance, the particles in the lipid element have, in overall, an irregular, non-spherical shape.

Thus, in the context of the presently disclosed subject matter, it is to be understood that a majority of the lipid bodies are not spherical.

Further, in the context of the presently disclosed subject matter, it is to be understood that a majority of the lipid bodies do not have a shape of lipid droplets.

As used herein, the term “majority” is to be understood that at least 50% of the lipid bodies would not be considered, by simple view with a microscope, to have a spherical shape and/or to have a shape of a droplet.

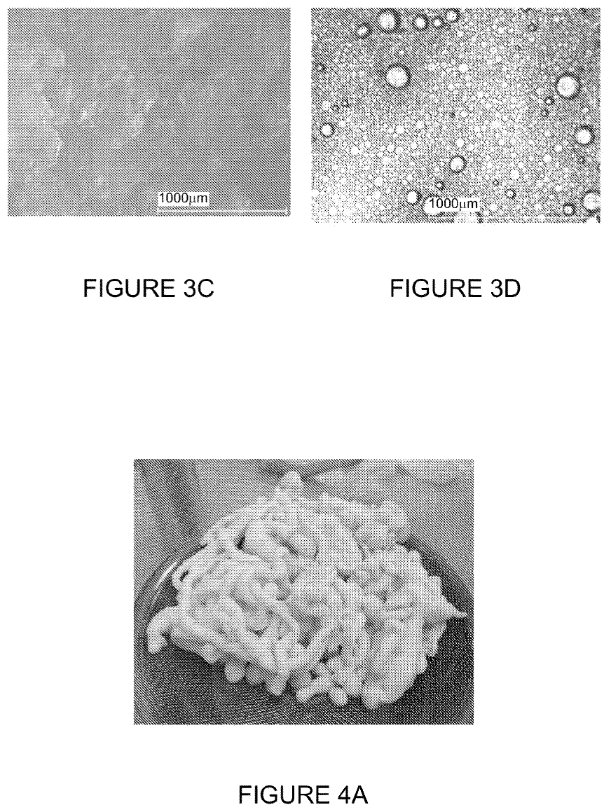

Further, in the context of some preferred examples of the presently disclosed subject matter, it is to be understood that when referring to distinct lipid bodies it means solid or semi-solid lipid bodies that are clearly visible in microscope as distinct bodies or particles embedded in the continuous gel matrix. The distinct bodies may be, and at times, are in contact with at least one other lipid body in the matrix (i.e. the bodies are not isolated bodies), as evident from the non-limiting examples of FIGS. 3A-3B.

In some examples of the presently disclosed subject matter, these distinct bodies are defined by average dimensions of or maximal cross-sectional dimension.

In some examples of the presently disclosed subject matter, the lipid bodies have a maximum cross-sectional dimension within a micrometer range along the body's largest axis.

In some examples of the presently disclosed subject matter, the lipid bodies have maximum cross-sectional dimension in a range of between 1 μm and 1,000 μm; at times, between 1 μm and 900 μm; at times, between 1 μm and 800 μm; at times, between 1 μm and 700 μm; at times, between 1 μm and 600 μm; at times, between 1 μm and 500 μm; at times, between 1 μm and 400 μm; at times, between 1 μm and 300 μm; at times, between 10 μm and 300 μm; at times, between 50 μm and 300 μm; at times, between 10 μm and 900 μm; at times, between 50 μm and 900 μm; at times, between 10 μm and 1,000 μm.

In some examples of the presently disclosed subject matter, the lipid material or more generally the lipid element is animal free or comprises or consists of non-animal derived lipids.

In some examples of the presently disclosed subject matter, the lipid material or more generally the lipid element is plant based or comprises one or more plant derived lipids.

In some examples of the presently disclosed subject matter, the lipid material or more generally the lipid element comprises at least one lipid selected from the group consisting of cocoa butter, coconut oil, palm oil, Illipe butter, Shea butter, avocado oil, peanut oil, oat oil and any mixtures of same. In some examples of the presently disclosed subject matter, these lipids are considered to constitute a first lipid in the lipid material. This is particularly relevant when the lipid material comprises lipids that do not fall under the definition of being solid or semi solid at least at a temperature of 10° C.

In some examples of the presently disclosed subject matter, the lipid material or, more generally, the lipid element comprises at least cocoa butter.

In some examples of the presently disclosed subject matter, the lipid material or, more generally, the lipid element comprises at least coconut oil.

In some examples of the presently disclosed subject matter, the lipid material or, more generally, the lipid element comprises at least palm oil.

In some examples of the presently disclosed subject matter, the lipid material or, more generally, the lipid element comprises at least Illipe butter.

In some examples of the presently disclosed subject matter, the lipid material or, more generally, the lipid element comprises at least Shea butter.

In some examples of the presently disclosed subject matter, the lipid material or, more generally, the lipid element comprises at least avocado oil.

In some examples of the presently disclosed subject matter, the lipid material or, more generally, the lipid element comprises at least peanut oil.

In some examples of the presently disclosed subject matter, the lipid material or, more generally, the lipid element comprises at least oat oil.

In some examples of the presently disclosed subject matter, the lipid material or, more generally, the lipid element comprises at least a combination of coconut oil and oats oil.

In some examples of the presently disclosed subject matter, the lipid material or, more generally, the lipid element comprises at least a combination of coconut oil and peanut oil.

In some examples of the presently disclosed subject matter, the lipid material or, more generally, the lipid element comprises at least a combination of coconut oil and cocoa butter.

In some examples of the presently disclosed subject matter, the lipid material or, more generally, the lipid element comprises at least a combination of coconut oil and avocado oil.

In some examples of the presently disclosed subject matter, the lipid material or, more generally, the lipid element comprises at least a combination of coconut oil and oats oil.

In some examples of the presently disclosed subject matter, the lipid material, or, more generally, the lipid element comprises an oleogel.

In some examples of the presently disclosed subject matter, the lipid material, or, more generally, the lipid element comprises as an additional lipid, a hydrogenated lipid.

In some examples of the presently disclosed subject matter, the lipid material comprises a mixture of at least one first lipid being solid or semi-solid at least, at a temperature of 10° C. as defined hereinabove, and at least one additional lipid, the mixture of lipids (i.e. the at least one first lipid, and the at least one second lipid) being solid or semi-solid at least at a temperature of 10° C.

The hydrogenated lipid is preferably an edible hydrogenated lipid.

A non-limiting list of possible hydrogenated lipids include, hydrogenated rapeseed lipids, hydrogenated sunflower lipids, hydrogenated cottonseed lipids and hydrogenated soybean lipids and any combination of same.

In some examples of the presently disclosed subject matter, the additional lipid comprises or is hydrogenated rapeseed lipids.

In some examples of the presently disclosed subject matter, the additional lipid comprises or is hydrogenated sunflower lipids.

In some examples of the presently disclosed subject matter, the additional lipid comprises or is hydrogenated cottonseed lipids.

In some examples of the presently disclosed subject matter, the additional lipid comprises or is hydrogenated soybean lipids.

In some examples of the presently disclosed subject matter, the additional lipid comprises or is hydrogenated palm oil.

In some examples of the presently disclosed subject matter, the additional lipid comprises or is olive oil.

In some examples of the presently disclosed subject matter, the lipid material or, more generally, the lipid element comprises at least a combination of coconut oil, oats oil and olive oil.

In some examples of the presently disclosed subject matter, the lipid material or, more generally, the lipid element comprises at least a combination of coconut oil, peanut oil and olive oil.

In some examples of the presently disclosed subject matter, the lipid material or, more generally, the lipid element comprises at least a combination of coconut oil, cocoa butter and olive oil.

In some examples of the presently disclosed subject matter, the lipid material or, more generally, the lipid element comprises at least a combination of coconut oil, avocado oil and olive oil.

In some examples of the presently disclosed subject matter, the lipid material or, more generally, the lipid element comprises at least a combination of coconut oil, oats oil and olive oil.

The lipid element also comprises water. To form the desired lipid element, the amount of water is at least 10 wt %; at times, at least 15 wt %; at times, at least 20 wt %; at times, at least 25 wt % out of the total weight of the lipid element.

In some examples of the presently disclosed subject matter, the lipid element comprises between about 10 wt % and 60 wt % water out of a total weight of the lipid element; at times, between 15 wt % and 60 wt %; at times, 20 wt % and 60 wt % water; at times, between 10 wt % and 50 wt %; at times, between 10 wt % and 40 wt %; at times, between 15 wt % and 50 wt %; at times, between 15 wt % and 40 wt %; at times between 15 wt % and 30 wt %, out of a total weight of the lipid element.

The lipid element can be of any shape and/or dimension. In some examples of the presently disclosed subject matter, the lipid element has a shape selected from a sheet, a strand, a cube, a sphere, an amorphous shape and any combination of same.

In some examples of the presently disclosed subject matter, the lipid element has the shape of a strands.

In some examples of the presently disclosed subject matter, the lipid element has the shape of a discrete sheet.

In some examples of the presently disclosed subject matter, the lipid element is defined by a cartesian coordinate system including x-axis (defining for example the element's length), z-axis (defining the element's width) and y-axis (defining the element's height or thickness). According to this coordinate system, the lipid element can be defined, in accordance with some examples of the presently disclosed subject matter, by at least one dimension as being at least 50 μm. In some examples, the dimension being at least 50 μm can represent the thickness (or cross-sectional dimension) of the element, where other dimensions according to the cartesian coordinate system are greater than the thickness.

In some examples of the presently disclosed subject matter, the lipid element has a thickness (or cross-sectional dimension) of at least 100 μm; at times, of at least 500 μm; at times, of at least 1 mm; of at least 5 mm; at times, of at least 1 cm; at times, of at least 1.5 cm; at times, of at least 2 cm; at times of at least 2.5 cm; at times of at least 3 cm; at times, of at least 3.5 cm; at times, of at least 4 cm; at times, of at least 4.5 cm; at times, even 5 cm.

In some examples of the presently disclosed subject matter, the lipid element has a thickness (or cross-sectional dimension) of between 50 μm and 10 cm. It is to be appreciated that any thickness (or cross-sectional dimension) or thickness average or thickness range that falls within this range, even if not explicitly or literally defined, constitutes part of the present disclosure.

In some examples of the presently disclosed subject matter, the lipid element is intended for use in the animal free alternative meat industry. To this end, not only the lipid is of non-animal source, but also the hydrocolloid forming material is of non-animal source.

The lipid element disclosed herein can be characterized by one of more physical parameters.

In some examples, the physical parameter is the lipid element's compression strength.

The compression strength value can be calculated from the maximum stress value observed during a compression test conducted at room temperature (25° C.) or at about 50° C., using a TA1 Series Texture Analysis machine (LLOYD TA1), a load cell of 100N with parallel plates, at a test speed of 90 mm/min, with a strain percentage set to 50%. The test includes 2 cycles within the Texture Analysis machine; a first cycle strength calculated from the maximum stress achieved up to 50% strain of the first compression cycle; and a second cycle strength calculated from the maximum stress achieved up to 50% strain of the second compression cycle. The eventual value is the highest of the two measurements.

The compression test is conducted on a cubic specimen of the lipid element having dimensions of 15 mm (15 mm*15 mm*15 mm).

In some examples of the presently disclosed subject matter, the compression strength of the lipid element, as determined by the above-described compression test, is at least 10 KPa, when measured at room temperature or even at about 50° C.; at times, at least 12 KPa; at times, 14 KPa; at times; 16 KPa; at times, 18 KPa; at times, 20 KPa.

In some examples of the presently disclosed subject matter, when the hydrocolloid forming material comprises a hydrocolloid agent that forms into a gel by cross-linking, e.g. alginate, the lipid element is characterized by a compression strength of at least 50 KPa at 25° C., and/or of at least 10 KPa at 50° C.

In some examples of the presently disclosed subject matter, when the hydrocolloid forming material comprises a hydrocolloid agent that forms into a gel by heating, e.g. methyl cellulose, the lipid element is characterized by a compression strength of at least 10 KPa at 25° C., and/or of at least 50 KPa at 50° C.

For example, Table 1 provides the compression strength at 25° C. and 50° C., for alginate-cocoa butter lipid element and methyl cellulose (MC)-cocoa butter lipid element (average of three measurements). The two examined lipid elements comprised between about 65%-67% lipid material.

TABLE 1
Compression Strength

| Lipid Element | 25° C. | 50° C. |
|---|---|---|
| Alginate-cocoa butter | 88 KPa | 24 KPa |
| MC- cocoa butter | 23 KPa | 70 KPa |

Table 1 shows a different behavior between the alginate-cocoa butter element and the MC-cocoa butter element, at the different temperatures. The alginate-based lipid element is harder at RT as compared to cooking temperature (50° C.) and softens by heating; this being similar to animal fat. The MC-based lipid element is softer at RT and yet hardens by heating to 50° C. Both can be manipulated into alternative meat products as alternatives to animal fat, as long as they are not liquid at room temperature or even at a temperature of up to 50° C. In some cases, while MC-based lipid element behaves less similar to animal fat, it is easier to process it at room temperature, e.g. during the fabrication of alternative meat product.

In some examples of the presently disclosed subject matter, the lipid element is characterized by its storage modulus, G′, as determined by a Temperature Sweep Test, on a disc specimen having a diameter of 40 mm and thickness of 1 mm, analyzed by Shear Rheometer (Discovery HR20, TA) using 40 mm stainless steel, sandblasted parallel plates, strain of 0.6%, and frequency of 10 Hz, and the test being performed at a temperature range of 5° C.-90° C.

In some examples of the presently disclosed subject matter, the lipid element is characterized by a storage modulus at 25° C. of between about 1,000 Pa (1 KPa) and about 10,000 Pa (10 KPa) as determined by the shear Rheometer test described above.

In some examples of the presently disclosed subject matter, the lipid element is characterized by its storage modulus at 50° C. of between about 0.05 KPa and about 10 KPa as determined by the shear Rheometer test described above.

The presently disclosed subject matter also provides, in accordance with a second of its aspects, a food product comprising one or more lipid elements according to the first aspect of the presently disclosed subject matter.

The food product can be of any type that requires the inclusion of a lipid element of a type as presently disclosed. In some examples of the presently disclosed subject matter, the food product is an animal-free meat analogue product, namely a product that mimics a food product including animal derived components.

Without being limited thereto, the food product of the presently disclosed subject matter is any one of meat alternative. In the context of the presently disclosed subject matter it is to be understood that the term meat encompasses any type of meat, including any livestock animal meat, aquatic animal meat, poultry meat etc.

In some examples of the presently disclosed subject matter, the lipid element forms part of alternative meat products, as further discussed hereinbelow.

In some examples of the presently disclosed subject matter, the lipid element forms part of alternative meat slab or alternative steak, as further discussed hereinbelow.

In some examples of the presently disclosed subject matter, the lipid element forms part of alternative dairy products that are solid or semi solid dairy at least at room temperature.

The food product can have any shape or dimension. In some examples, the food product has a shape and/or dimension similar to that of the food product of which it is aiming to mimic.

When forming part of a food product, the lipid element can be combined with other components of the alternative, animal free, food product. In some examples, the lipid element is combined with components that comprise proteins and/or are protein rich and can constitute a protein mass/a protein containing component within the product.

In the context of the present disclosure, when referring to a protein mass or a protein containing component it is to be understood to denote a composite of matter that contains at least 10% w/w protein(s) (i.e. one or more protein/peptide/amino acid), at times, at least 20% w/w proteins; at times, at least 30% w/w proteins. Further, in the context of the present disclosure, the protein containing component comprises at least 50% w/w water.

In the context of the present disclosure, the protein of the protein containing component is or comprises at least plant-based protein(s). In this connection, it is to be understood to encompass plant-derived (e.g. isolate or concentrate) edible protein(s) and/or peptide(s) and/or amino acids.

Without being limited thereto, the plant source for the protein, in the plant derived protein, can be any one or combination of soy, wheat, legume (pulses, beans, peas, lentils, nuts), plant seeds and grains (e.g. sunflower, canola, rice), stem or tuber protein (e.g. potato protein), rapeseed and corn.

In some examples of the presently disclosed subject matter, the protein is derived from legume. Specific, yet non-limiting examples of legume/bean proteins include, soy protein, pea protein, chickpea protein, lupine protein, mung-bean protein, kidney bean protein, black bean protein, alfalfa protein.

In some examples of the presently disclosed subject matter, the protein containing component can comprise proteins from other sources.

For example, the protein can be derived from sources other than plants, such as algae, fungi (e.g. yeast), bacteria and microorganisms in general

A non-limiting list of proteins that are not considered plant-derived include beta-gonglycinin, glycinin, vicilin, legumin, albumins, globulins, glutelins, gluten, gliadins, glutenins, mycoproteins and combinations of same.

The protein containing component can comprise, in accordance with some examples, other, non-protein material, such as polysaccharides, e.g. Guam gum, Xanthan gum, k-Carrageenan, chitosan, cellulose, starch and/or lignin.

Further, the protein containing component can comprise, in accordance with some examples, fat. Yet, even if fat is included, the protein constitutes the majority of the (non-water) material in the protein containing component. In this context, the majority denotes at least 50% w/w out of the dry matter (i.e. without the water).

In some further examples, the lipid element is combined with components that are fluid, e.g. aqueous based.

In some examples of the presently disclosed subject matter, the food product comprises different components, at least one component being or comprising the lipid element of the presently disclosed subject matter. In some preferred examples, at least one other component is the protein containing component.

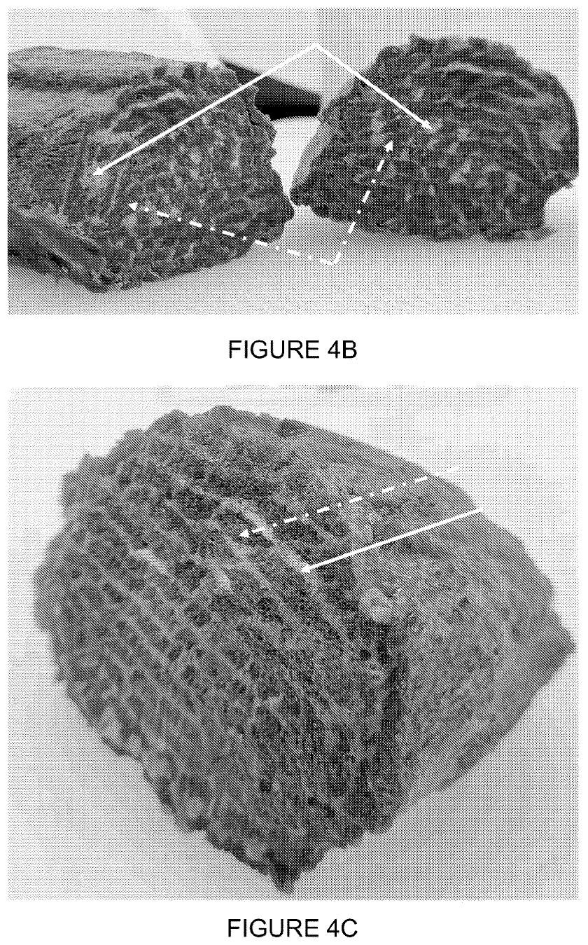

In some examples of the presently disclosed subject matter, the different components are distinct components within the product (i.e. not homogenously blend), that can be identified by a simple eye inspection, as seen, for example, in FIGS. 4B and 4C.

In some examples of the presently disclosed subject matter, the food product is an alternative meat product, and preferably an alternative whole muscle cut product, where the lipid element disclosed herein constitutes an alternative to the animal fat within true meat.

In some examples of the presently disclosed subject matter, the food product and in some examples, the whole muscle cut meat analogue product is characterized by juiciness of the lipid element therein, of at least 50% as determined using an equation provided hereinabove and wherein the weight after compression can be or is determined or determinable following a compression test on a disc sample of the lipid element, after isolating it from the food product, under the compression test conditions defined hereinabove. To this end, lipid elements can be isolated from other components of the food product by slicing it out, or by other means, and if necessary, combining several isolated lipid elements into a disc shaped sample suitable for conducting thereon the compression test.

The presently disclosed subject matter also provides, in accordance with a third of its aspects, methods of producing a lipid element of the presently disclosed first aspect.

For the sake of simplicity all terms and definitions relating to the lipid element and/or the product comprising it, also apply to the herein disclosed methods, mutatis mutandis.

The method of the presently disclosed subject matter is based on the realization that when desiring to imitate animal fat within animal derived food products, it is advantageous to capture or entrap lipid material, that is solid or semi solid (i.e. not fluid), at least at 10° C., within a hydrocolloid matrix, with the lipid material being essentially homogenously dispersed within the matrix.

The presently disclosed method comprises mixing lipid material that is solid or semi solid at least at a temperature of 10° C., with a hydrocolloid aqueous solution comprising a hydrocolloid forming agent to form a mixture;
wherein said mixing is at a temperature by which said lipid material is solid or semi solid; and
wherein said mixing of the mixture allows formation of a continuous hydrocolloid matrix having, at least at 10° C., dispersed therein the lipid material in solid or semi solid form.

In some examples of the presently disclosed subject matter, the method comprises suspending powder of lipid material that is solid or semi solid at least at a temperature of 10° C., with a hydrocolloid aqueous solution comprising a hydrocolloid forming agent to form a hydrocolloid suspension (the mixture being a suspension and not an emulsion); and mixing the hydrocolloid suspension to allow formation of a continuous hydrocolloid matrix from said hydrocolloid forming agent, the matrix having, at least at said temperature of 10° C., dispersed therein said lipid material in solid or semi solid form.

In some examples of the presently disclosed subject matter, the method comprises suspending powder of lipid material that is solid or semi solid at least at a temperature of 10° C., with a hydrocolloid aqueous solution comprising a hydrocolloid forming agent to form a hydrocolloid suspension (the mixture being a suspension), the amount of said lipid material constituting at least 50 wt % out of a total weight of said lipid element; and
mixing the hydrocolloid suspension to allow formation of a continuous hydrocolloid matrix from said hydrocolloid forming agent, the matrix having, at least at said temperature of 10° C., dispersed therein said lipid material in solid or semi solid form.

In the context of the method of the presently disclosed subject matter, the lipid material, can comprise one or more lipids that in combination are solid or semi solid at least at a temperature of 10° C. When the lipid material includes a single lipid, the single lipid is solid or semi solid at least at a temperature of 10° C. In other words, the lipid material is solid or semi-solid at least at 10° C., irrespective of the number of different lipids included therein.

The lipid material, be it a single lipid or a combination of lipid is mixed with the hydrocolloid aqueous solution in powder form. The powder can include a single lipid or can be a mixture of lipids sheared together until a mixed powder is formed. Alternatively, each lipid can be powdered separately and mixed together or sequentially into the hydrocolloid aqueous solution.

In some examples of the presently disclosed method, the powder of lipid material is obtained commercially or by using a grinder operated at low temperatures and preferably in pulses, to ensure the lipid does not soften and/or melts. A person of average skill in the art would be able to determine the temperature and extent of pulsation to avoid the undesired softening of the lipid material.

Once the lipid element is suspended within the hydrocolloid aqueous solution, matrix formation can take place. Thus, in accordance with some examples, the lipid material, preferably in solid or semi-solid form is entrapped within the matrix during the matrix formation.

In some examples, the matrix formation is facilitated by cross-linking.

In some examples, the complete matrix formation is facilitated by heating the hydrocolloid mixture. At times, and in accordance with some examples of the presently disclosed subject matter, cross linking requires the presence of a cross linking agent. Thus, in accordance with some examples of the presently disclosed subject matter, the method comprises mixing into the hydrocolloid aqueous solution a cross linking agent. The cross-linking agent is typically added when it is dissolved within an aqueous solution, thus forming a cross linking aqueous solution.

The addition of the cross-linking agent to the hydrocolloid forming agent can be during or after the mixture is formed.

In some examples, the cross-linking agent is mixed into the hydrocolloid aqueous solution together with the mixing of the lipid powder.

In some examples, the cross-linking agent is mixed into the mixture during or after mixing of the hydrocolloid forming agent with the lipid material.

In some examples, the cross-linking agent is mixed into the lipid material prior to mixing the lipid material with the hydrocolloid aqueous solution.

In some examples of the presently disclosed subject matter, the cross-linking agent is introduced into the hydrocolloid mixture after the hydrocolloid mixture is at rest. In the context of the present disclosure, the term “at rest” or “allowed to rest” means that no mixing takes place prior to combining with the cross-linking agent.

In some examples of the presently disclosed subject matter, the cross-linking agent is introduced into the mixture when the latter is already within a desired mold and at rest. Once the cross-linking agent is introduced, mixing can take part to ensure essentially even distribution of the cross-linking agent within the mixture, while the latter is within its mold.

The presently disclosed method may also comprise, in accordance with some examples, providing the hydrocolloid mixture including the hydrocolloid forming agent and the cross-linking agent a curing time sufficient to permit cross linking of the hydrocolloid with the cross-linking agent.

As noted above, the hydrocolloid forming agent, and the cross-linking agent that form part of the disclosed method, have the same meaning as defined with respect to the lipid element.

In some examples of the presently disclosed subject matter, the lipid element comprises as a hydrocolloid forming agent, alginate, and the cross-linking agent is an edible salt. To this end, the hydrocolloid aqueous solution comprises said alginate and water and the cross-linking solution comprises the salt in water. When the hydrocolloid forming agent is or comprises alginate, there are different salts known to be suitable for cross linking the alginate, and each can be used in the context of the present disclosure.

In some particular examples, the hydrocolloid forming agent comprises alginate and the cross-linking agent comprises a calcium salt.

In some examples of the presently disclosed subject matter, the hydrocolloid matrix is formed without the need of a cross linking agent. In these cases, the hydrocolloid forming agent is one that spontaneously forms into a gel, preferably with heating, e.g. methyl cellulose.

The ratio between the hydrocolloid forming agent and the lipid material can vary depending on the type of hydrocolloid to be formed, the lipid and other parameters. However, in some examples of the presently disclosed subject matter, the hydrocolloid:lipid weight ratio is between about 1:1 and about 1:10.

In some examples of the presently disclosed subject matter the weight ratio between the hydrocolloid and the lipid element is between about 1:1 and about 1:9; at times, between about 1:1 and about 1:8; at times, between about 1:1 and about 1:7; at times, between about 1:1 and about 1:6; at times, between about 1:1 and 1:5; at times, between about 1:1 and 1:4.

In some examples of the presently disclosed method, the hydrocolloid:lipid element weight ratio is between about 1:1.5 and about 1:4.

In the context of the presently disclosed subject matter, the term “mixing” should have its acceptable meaning and can be executed by any means known in the art, except forming an emulsion. Yet, in some examples of the presently disclosed, the mixing of the suspension is under mixing mechanism configured to apply shear forces onto the material being mixed under conditions (e.g. temperature and/or speed) that result in an essentially homogenous dispersion of the solid or semi solid lipid bodies in the hydrocolloid forming media.

In some examples, the high shear mixing is obtained by a high shear mixer.

In some examples of the presently disclosed method, the mixing is done by co-extrusion of the hydrocolloid mixture with the aqueous solution comprising the cross-linking agent.

As noted above, the lipid element of the presently disclosed subject matter can then be used for producing an alternative meat product. To this end, the lipid element is combined with protein mass/protein containing component, as further described hereinbelow.

In some examples of the presently disclosed subject matter, the lipid element is combined with the protein containing component to form alternative whole cut meat products.

In some examples of the presently disclosed method, the whole cut meat alternative is combined with the protein containing component, i.e. is produced or producible by additive manufacturing techniques, e.g. 3D printing.

In some examples of the presently disclosed method, strands of protein mass, such as TVP and strands of the presently disclosed fat element are provided.

Thus, in accordance with the presently disclosed subject matter, there is also provided a method of producing a whole cut meat analogue, the method comprising dispensing a plurality of stacked layers, each layer comprising essentially aligned protein strands, wherein at least part of the plurality of layers includes intermittently dispensed lipid element disclosed herein, the lipid element being disposed according to a predefined pattern.

In some examples of the presently disclosed subject matter, the lipid element is in a form of strands, dispensed between at least part of the protein strands.

In some examples of the presently disclosed subject matter, the lipid element is dispensed as elongated strands essentially parallel to the nominal direction of the essentially aligned protein strands.

In some examples of the presently disclosed subject matter, the lipid element is dispensed as elongated strands between strands of protein mass, within an individual layer.

In some examples of the presently disclosed subject matter, the lipid element is dispensed as elongated strands between layers of protein mass.

In some examples of the presently disclosed subject matter, the strands of the lipid element can be obtained by extrusion. Extrusion can be via any nozzle, with preference to nozzles opening with an internal cross section within the 0.2 mm-10 mm range, or at times, within the 1-10 mm range.

In some other examples of the presently disclosed subject matter, strands of the lipid element can be obtained by slicing of sheets of the lipid element (the latter being obtained by, for example, curing within a mold).

In some other examples of the presently disclosed subject matter, the lipid element is dispensed while being intermixed with protein containing component. In this context, intermixing is to be understood to cover any manner by which two different materials are mixed together. Such mixing may result in the formation of a blend of the two different materials, such that the distinction between the two different materials is also apparent in the final product. For the sake of illustration, the two different materials can be the protein containing component and the lipid element which, for example, are visibly distinct in alternative minced meat.

In some other examples of the presently disclosed subject matter, the intermixing is achieved by dual extrusion or dual feeding of the lipid element and the protein containing component via a same nozzle.

In some other examples of the presently disclosed subject matter, the method of producing the alternative meat product comprises mixing protein containing component with the presently disclosed lipid element, wherein said protein containing component and said lipid element are each in particulate form, and as a result of mixing the lipid element to be dispensed, in particulate form, within the protein containing component s, also in particulate form.

When the alternative meat product is formed by mixing, the lipid element is preferably essentially evenly distributed within the protein containing component.

As used herein, the terms “a”, “an” and “the” include singular as well as plural references unless the context clearly dictates otherwise. For example, the term “a lipid” includes one or more lipids within the lipid material.

Further, as used herein, the term “comprising” is intended to mean that the composition include the recited components, e.g. lipid material and hydrocolloid forming material, but not excluding other elements, such as salts as well as other food additives.

The term “consisting essentially of” is used to define compositions which include the recited components but exclude other components that may have an essential significance on the properties of the lipid element. “Consisting of” shall thus mean excluding more than trace amounts of other components. Embodiments defined by each of these transition terms are within the scope of this invention.

Further, as used herein, the term “essentially” denotes some level of deviation, such as 1%, 2%, 3%, 10%, or even up to 20%, from a defined parameter.

In this context, when referring to “essentially aligned” it is to be understood to refer to the orientation of at least 80% of the strands, preferably 95% of the strands and preferably 99% of the strands, one with respect to the other when viewed within a specimen, to be parallel (with an acceptable deviation as defined above with respect to the term “essentially”). For example, the essential alignment is within a specimen having a dimension of at least 1 cm*1 cm*1 cm.

Further, the term “essentially aligned” should be understood to encompass the nominal direction of the longitudinal axis to be at most ±10°, at times, at most ±3°, at most ±1°.

The term “nominal direction” as used herein refers to a direction where significantly more than 50% of the strands have a direction of up-to ±45 degrees from that nominal direction, when the strand is viewed from any direction perpendicular to the strand direction. The term “nominal direction” may also refer to the average of the strands' direction as found using high magnification imaging as described herein. The nominal direction is a solid angle, where its projection on each of the 2 views, is the average direction found at this view.

Further, all numerical values, e.g. when referring the amounts or ranges of the components constituting aspects or examples of the presently disclosed subject matter are approximations which are varied (+) or (−) by up to 20%, at times by up to 10% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF NON-LIMITING EXAMPLES

### Example 1: Calcium Alginate-Cocoa Butter Element

### Calcium Alginate-Cocoa Butter Element Preparation

Hydrocolloid forming solutions were prepared:

Solution A: 1% Sodium Alginate (ALGINEX GM, Kimica, Tokyo, Japan) was dissolved in filtered water and mixed in a blender, using high shear forces until a homogenous solution is formed (about a minute).

Solution B (gelling agent): 0.75% Calcium-Lactate solution in filtered water was made also using a blender with high shear forces.

To prepare a hydrocolloid-lipid mixture, fine powder cocoa butter (obtained by grinding a cooled butter block) was mixed with Solution A, at a ratio of 2 parts Cocoa butter powder+1 part solution A to obtain hydrocolloid suspension. The mixing of the cooled, fine powder cocoa butter and Solution A was at room temperature (about 22-25° C.), i.e. at which the cocoa butter maintains its powder form (i.e. is solid or semi solid).

Then, the hydrocolloid suspension was poured into a mold containing Solution B to obtain a cross linkable alginate-cocoa butter mixture (1 part of the suspension and 3 parts of the cross-linking solution). Also this mixing was at a room temperature (to maintain the dispersed cooled powder in its powder/particulate form). The calcium ions were allowed to diffuse into the alginate-cocoa butter mixture. The presence of the calcium ions resulted in cross-linking/curing at room temperature until solidification to provide the desired lipid element where the cocoa butter is entrapped within the calcium alginate cross linked matrix as fine lipid bodies.

### Calcium-Alginate-Cocoa Butter Element Characterization

### Storage Modulus Measurements

Temperature dependent storage shear modulus (Temperature Sweep Test) of the solid alginate-cocoa butter element was determined.

The storage shear modulus test was performed on discs of 40 mm in diameter and 1 cm thick, analyzed by Shear Rheometer (Discovery HR20, TA) using 40 mm stainless steel, sandblasted parallel plates, strain of 0.6%, and frequency of 10 Hz. The tested temperature range was 5° C.-90° C.

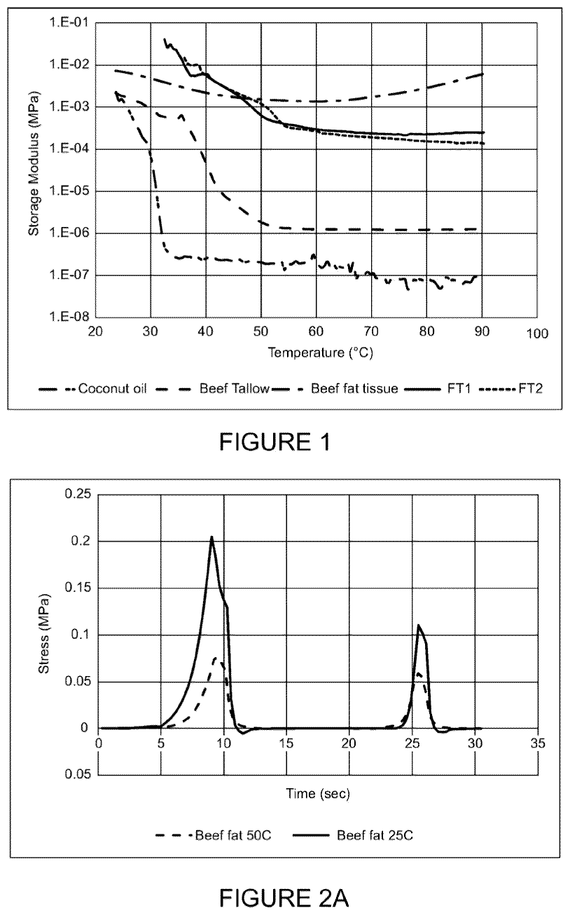

FIG. 1 provides the Storage Shear Modulus (G′) determined by the Sweep Test as described above for coconut oil alone, beef tallow, beef fat tissue, and two repetitions (“FT1” and “FT2”) of the solid alginate-cocoa butter element produced according to this non-limiting Example.

FIG. 1 shows that the two repeated measurements (FT1 and FT2) of a tested sample maintained a storage modulus above 0.1 KPa (1E-04 MPa) at the entire range of temperatures 35°−90° C. The comparison to coconut oil alone shows that the use of the hydrocolloid material strengthens the fat/lipid component significantly and is thus required in order to mimic animal fat.

### Compression Strength

Cubic specimens (15 mm×15 mm×15 mm) were cut from the samples and subjected to compression test using TA1 Series Texture Analysis machine (LLOYD TA1). Some specimens were tested at ambient temperature (25° C.), while others were pre-heated to 50° C. A 100N load cell was used with parallel plates setup at a test speed of 90 mm/min, performing 2, 50% compression cycles. The compression strength value was calculated from the max stress value observed during the test. First cycle strength was calculated from the max stress achieved up to 50% strain of the first compression cycle. Second cycle strength was calculated from the max stress achieved up to 50% strain of the second compression cycle.

Table 2 provides the average (three repetitions) compression strength. The value presented is the highest of the two measurements of the lipid element, at 25° C. and at 50° C.

TABLE 2
Compression Strength (kPa) of Calcium-Alginate-Cocoa Butter
Element at 25° C. and at 50° C.

Compression Strength (kPa)*

| Sample | 25° C. | 50° C. |
|---|---|---|
| Alginate-Cocoa Butter element | 92.12 ± 13.29 | 26.27 ± 4 |

*Average of 3 repetitions

Table 2 shows that the lipid element's compression strength decreases at higher temperatures, meaning that the lipid element softens upon heating when based on alginate as the hydrocolloid.

In addition, the data was plotted in a stress vs time for observing the two cycles behavior in time.

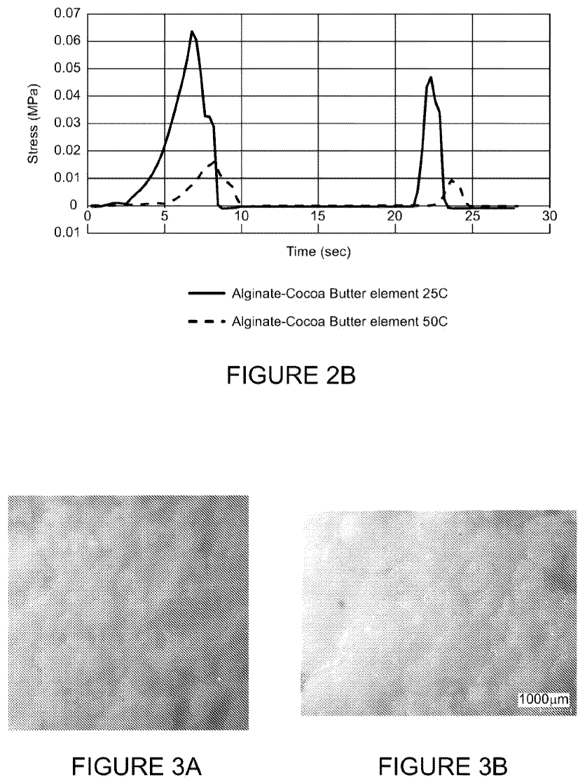

Specifically, FIG. 2A provides the behavior in time of live-stock (beef) fat; while FIG. 2B provides the behavior in time of alginate-cocoa butter lipid element of this Example 1.

FIG. 2A shows that the live-stock fat is resisting compression at both cycles, while at the second cycle, the resistance is lower, indicating partial failure of the live-stock fat structure. At 50° C. the fat element is substantially softer and weaker than at room temperature, yet, even at 50° C. the live-stock fat provides a noticeable resistance to compression, indicating that it preserves its structural integrity even above the beef's fat melting temperature (42-45° C.).

Turning to FIG. 2B, the behavior of the alginate-cocoa butter lipid animal is plotted. Specifically, it shows that the lipid element has a behavior that resembles that of the live-stock fat (FIG. 2A), i.e. it preserves its integrity and is resistant to compression, at both compression cycles, even at the elevated temperature of 50° C.

### Water Content

Water content of the alginate-cocoa butter element was analyzed by Moisture Analyzer (HE73, Mettler Toledo), at a drying temperature of 105° C., standard drying mode, switch off was based on a weight loss per unit of time (Manufacturer's setting).

Table 3 provides the water content, under the test condition, of three cubic (15 mm*15 mm*15 mm) samples (Samples 1, 2, 3) of a same alginate-cocoa butter-based element.

TABLE 3
Water content of the tested cubic samples.

| Sample | Water content (wt %) |
|---|---|
| Alginate-Cocoa Butter element | 29.00 ± 4.22 |

* Average of 3 repetitions

Table 3 shows that the lipid element comprised of cross-linked calcium alginate and cocoa butter had a water content above 24%.

### Example 2A—Methyl Cellulose Cocoa Butter Element

### Methyl Cellulose Cocoa Butter Element Preparation

A solution of activated methyl cellulose was prepared by mixing 5 wt % methyl cellulose with 95 wt % filtered water. The mixing was performed under high shear conditions using a mechanical mixer (Ninja), for 2-3 minutes, until a homogenous suspension is obtained under eye inspection.

Cocoa butter powder (obtained by grinding a butter block) was then immediately mixed into the activated methyl cellulose to receive a final concentration of lipid material of about 65% (a weight ratio of methyl cellulose hydrocolloid to butter of about 2:3). Similar to Example 1, the mixing was at room temperature, i.e. temperature at which the lipid material maintains its powdery form (about 22-25° C.). Shortly after mixing with the cocoa butter powder, a matrix is formed with the cocoa butter powder bodies entrapped within the matrix.

### Methyl Cellulose-Cocoa Butter Element Characterization

### Compression Test

Compression test was conducted as described in Example 1 (Compression Strength). To this end, cubic specimens (15 mm*15 mm*15 mm) of the methyl cellulose cocoa butter lipid element were cut and TPA results at 25° C. and 50° C., are presented in Table 4 (3 repetitions). The value presented is the highest of the two measurements of the lipid element.

TABLE 4
Compression Strength (kPa) of Methyl Cellulose-Cocoa Butter
Element at 25° C. and at 50° C.

| | Compression Strength (kPa)* | |
|---|---|---|
| Sample | 25° C. | 50° C. |
| Methyl Cellulose-Cocoa Butter element | 23.33 ± 2.04 | 77.33 ± 26.58 |

*Average of 3 repetitions

Table 4 shows that the lipid element's compression strength increases upon heating when based on methyl-cellulose as hydrocolloid.

### Water Content

Water content of the methyl cellulose butter element was analyzed by Moisture Analyzer (HE73, Mettler Toledo), at a drying temperature of 105° C., standard drying mode, switch off was based on a weight loss per unit of time (Manufacturer's setting).

Table 5 provides the water content, under the test condition, of three cubic (15 mm*15 mm*15 mm) samples of methyl cellulose-cocoa butter element.

TABLE 5
Water content of the tested cubic samples

| Sample | Water content (wt %) |
|---|---|
| Methyl Cellulose-Cocoa Butter element | 30.79 ± 2.59 |

* Average of 3 repetitions

Table 5 shows that the lipid element comprised of methyl cellulose cocoa butter has a water content above 25%.

### Example 2B—Methyl Cellulose with Palm Oil Lipid Element

### Methyl Cellulose Palm Oil Element Preparation

A solution of activated methyl cellulose was prepared by mixing 5 wt % methyl cellulose with 95 wt % filtered water. The mixing was performed under high shear conditions using a mechanical mixer (Ninja), for 2-3 minutes, until a homogenous suspension is obtained under eye inspection.

Palm Oil powder (obtained by grinding an oil block) was then immediately mixed into the activated methyl cellulose to receive a final concentration of lipid material of about 55% (a weight ratio of methyl cellulose hydrocolloid to oil of about 9:11). Similarly to Example 1 and 2A, the mixing was at room temperature, i.e. temperature at which the lipid material maintains its powdery form (about 22-25° C.). Shortly after mixing with the palm oil powder, a matrix is formed with the palm oil powder bodies entrapped within the matrix.

TABLE 6
Compression Strength (kPa) of Methyl Cellulose-Palm
Oil Element at 25° C. and at 50° C.

| | Compression Strength (kPa)* | |
|---|---|---|
| Sample | 25° C. | 50° C. |
| Methyl Cellulose-Palm Oil element | 96.0 | 313.7 |

*Average of 3 repetitions

Table 6 shows that the lipid element's compression strength increases upon heating when based on methyl-cellulose as hydrocolloid.

### Example 3—Juiciness and Cooking Loss of Lipid Element

The juiciness and cooking loss of the lipid elements of Examples 2A-2B were compared to an element containing coconut oil that was liquid at temperature of 25° C. (melting temperature of 24° C.) homogenously mixed into Agar-Agar gel based on the procedure described in US20220330573. In US20220330573 liquid oil is introduced into a in agar-agar gel by mixing the liquid oil into the aqueous hydrocolloid solution at low shear.

The juiciness test included heating three different elements comprised of: Calcium alginate+ground cocoa butter (Example 1); Methyl cellulose+ground cocoa butter (Example 2A), Methyl cellulose+ground Palm oil (Example 2B), and Agar-Agar+coconut oil (US20220330573).

Specifically, the comparison to US20220330573 (“reference element”) was made to show the difference between mixing hydrocolloid forming material with oil at solid (or semi solid) state (solid in liquid dispersion, according to the present disclosure) and oil that is in liquid state (liquid in liquid emulsion, according to US20220330573).

Juiciness test used texture profile analyzer (TPA) set with a load cell of 1KN, lower compression platen of 196 mm diameter, upper compression platen of 115 mm diameter and for compression of 100% of the tested specimen.

Each fat element was shaped to a disc having a diameter of 2.5 cm and disc thickness of 2 cm (in average), and a thermometer was introduced from the side into the center of each element. Each element was then cooked in a kitchen toaster set to a temperature of 170° C. When the thermometer indicated that the fat element reached a core temperature of 50°, the element was flipped on the other side and continued heating until a core temperature of 75° C. Each cooked element was then immediately weighted to set the weight of the sample before compression (“weight after cooking”).

The % of weight loss as a result of cooking, was calculated. It is essential to show that the cooking does not cause significant loss of the lipid that could affect the juiciness of the cooked product.

Each element was then cooled until reaching a core temperature of 60° C., wrapped in a water absorbing cloth, placed on the lower compression plate and subjected to compression under the above set parameters.

The compressed element was then weight and the % juiciness was calculated according to the following equation:

$$\frac{Weight before - Weight after}{Weight before} = \% Juiceness$$

Table 7 provides the % of weight loss after cooking, and the % juiciness of each tested fat element.

TABLE 7
% Cooking Loss and Juiciness

| | Ca- | Methyl | | |
|---|---|---|---|---|
| | Alginate + | Cellulose + | Methyl | |
| | Cocoa | Cocoa | cellulose + | Agar-Agar + |
| | Butter | Butter | Palm Oil | Coconut Oil |
| Cooking Loss | 32 ± 3% | 17 ± 4% | 25 ± 1% | 29 ± 2% |
| Juiciness | 86 ± 2% | 71 ± 3% | 66 ± 3% | 40 ± 2% |

Further, Table 11 shows that all samples, are capable of maintaining a significant amount of the lipid upon cooking, i.e. that there is no lipid loss as a result of heating the product. The minimal lipid loss upon cooking exhibits an advantage over using un-trapped lipids, i.e. free lipids.

Table 7 further shows that the amount of liquid extracted during compression of the element (at 60° C.) was significantly greater in the lipid elements based on any one of Ca-Alginate+cocoa butter, methyl cellulose+cocoa butter element or methyl cellulose+palm oil, which are produced in accordance with the presently disclosed subject matter, as compared to the reference based on Agar-Agar+Coconut oil.

Without being bound by theory, it is believed that the use of irregular solid (or semi solid) oil particles when forming the fat elements of the presently disclosed subject matter, as compared to the entrapment of liquid oil droplets in the Agar-Agar matrix according to US20220330573 is one of the reasons for the unexpectedly increased juiciness.

The inclusion of large irregular solid cocoa butter chunks in the hydrocolloid is viewed in the microscopic images of FIG. 3A showing Ca-Alginate+Cocoa Butter lipid element according to one example, and FIG. 3B, showing methyl cellulose+cocoa butter lipid element according to another example. In both FIG. 3A and FIG. 3B the cocoa butter chunks dispersed in the continuous matrix are visible (examples are circled). In comparison, FIG. 3C shows the result of mixing coconut oil in liquid state with Agar-Agar in water, like the disclosure of US20220330573. FIG. 3C clearly shows a smooth gel with no microscopically visible solid and irregularly shaped chunks (as clearly viewed in FIGS. 4A and 4B).

For further comparison, liquid canola oil was mixed into methyl cellulose (2%), under shear forces sufficient to form an emulsion. FIG. 3D shows large air bubbles (having a thicker membrane, some identified by an arrow) and very small spherical oil droplets within a continuous matrix.

These results show that when mixing the oil with the gel forming material, both being in liquid state, spherical oil droplets are entrapped in the gel matrix, while when using solid or semi solid lipid particles (e.g. cocoa butter grinds) the particles are entrapped as dispersed large chunks.

### Example 4—Fabrication of a Whole Alternative Meat Slab Containing Alginate Based Edible Lipid Elements

A whole alternative meat slab including the alginate-cocoa butter element of Example 1 was prepared.

Specifically, strands of TVP were prepared by slicing sheets of TVP extrudate to the dimensions of about 0.5 cm*0.5 cm.

Further, strands of the alginate-cocoa butter element were obtained by extrusion via a nozzle with an internal diameter of 3.4 mm and then brought into contact with a bath of calcium ions (1.5%). An image of multiple strands of extruded alginate-cocoa butter lipid elements is provided in FIG. 4A.

To construct the slab, strands of TVP and strands of the lipid elements are dispensed layer by layer, according to a predefined pattern. Specifically, a plurality of layers of essentially aligned TVP strands were stacked one on top of the other with at least some of the layers including intermittently added strands of the lipid element.

FIG. 4B shows a cross sectional cut of a slab (cut perpendicular to the plan of the stacked layers). FIG. 4B clearly shows the presence of fat containing segments (identified by the full arrows pointing to exemplary fat segments) embedded within TVP mass (identified by the broken arrow pointing to exemplary TVP segments).

FIG. 4C shows a cross sectional cut of a similar slab (cut perpendicular to the plan of the stacked layers) however, after cooking at 165° C. for about 12 minutes. FIG. 4C clearly shows that even after heating at elevated temperatures, for more than 10 minutes, the fat segments (identified by the full arrow pointing to an exemplary fat segment) remain intact and embedded within the TVP mass (identified by the broken arrow pointing to exemplary TVP segment).

### Example 5—Fabrication of a Whole Alternative Meat (Marbled) Slab Containing Methyl Cellulose Based Edible Methyl Cellulose-Cocoa Butter Element

A whole meat slab was manufactured layer by layer in a manner similar to that presented in Example 3, however, with strands of the methyl cellulose and cocoa butter-based lipid element (of Example 2A) being deposited by extrusion via a nozzle having an inner cross section of up to 10 mm.

Specifically, the slab was 3D printed on a printing bed using a first dedicated nozzle for dispensing of protein mass and a second dedicated nozzle for depositing of the methylcellulose-cocoa butter lipid element (of Example 2A above).

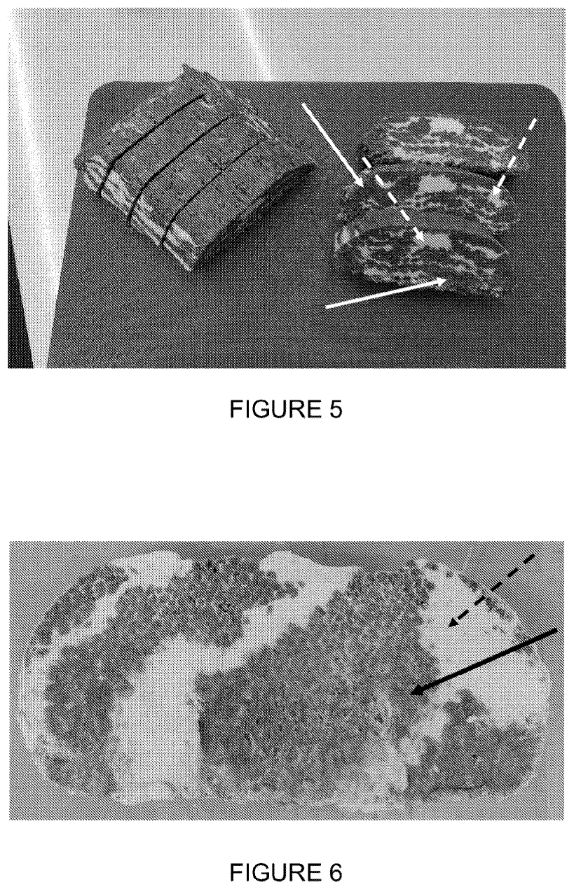

FIG. 5 provides a top view (left) and cross view of images of the resulting whole 3D printed slab. Specifically, marbles of lipid element, identified by the broken arrow, are embedded within or sandwiched between the protein mass, identified by the full arrow.

### Example 6—Fabrication of a Whole Alternative Meat (Marbled) Slab Containing Methyl Cellulose Based Edible Methyl Cellulose-Palm Oil Element

A whole meat slab was manufactured layer by layer in a manner similar to that presented in Example 3, however, with strands of the methyl cellulose and palm oil-based lipid element (of Example 2B) being deposited by extrusion via a nozzle having an inner cross section of up to 10 mm.

Specifically, the slab was 3D printed on a printing bed using a first dedicated nozzle for dispensing protein mass and a second dedicated nozzle for depositing of the methylcellulose-cocoa butter lipid element (of Example 2B above).

FIG. 6 provides a top view (left) and cross view of images of the resulting whole 3D printed slab. Specifically, marbles of lipid element, identified by the broken arrow, are embedded within or sandwiched between the protein mass, identified by the full arrow.

1-63. (canceled)

64. An edible lipid element, comprising:
a lipid material; and
a hydrocolloid having dispersed within the hydrocolloid the lipid material;
wherein said lipid material is solid or semi-solid at least at a temperature of 10° C.

65. The edible lipid element of claim 64, wherein lipid material dispersed in said hydrocolloid is in a form of distinct lipid bodies, said lipid bodies having an irregular shape and a cross-section dimension within a micrometer range.

66. The edible lipid element of claim 64, wherein said hydrocolloid comprises an edible hydrocolloid forming agent that forms into a gel by cross-linking or an edible hydrocolloid forming agent that forms into a gel by heating.

67. The edible lipid element of claim 64, wherein said lipid material comprises at least 30 wt % of one or more edible lipids out of a total weight of the lipid element and up to 90 wt % of said one or more edible lipids out of a total weight of the lipid element.

68. The edible lipid element of claim 64, wherein said lipid material comprises non-animal derived lipids and has a softening point or melting point at a temperature above 10° C. and below about 50° C.

69. The edible lipid element of claim 64, wherein said lipid material comprises a mixture of at least one first lipid being solid or semi-solid at least at a temperature of 10° C. and at least one additional lipid, the mixture of lipids being solid or semi-solid at least at a temperature of 10° C.

70. The edible lipid element of claim 64, further comprising water in an amount of between about 10 wt % and 60 wt % water out of a total weight of the lipid element.

71. The edible lipid element of claim 69, wherein when said edible hydrocolloid forming agent is one formed into a gel by heating, an amount of the at least one edible cross-linking agent is up to 3 wt % out of a total weight of lipid element, and when said edible hydrocolloid forming agent is one formed into a gel by cross-linking, said hydrocolloid forming material is present in the lipid element in an amount of between about 0.1 wt % and about 8.0 wt %.

72. The edible lipid element of claim 64, characterized by at least one of:
a compression strength of at least 10 KPa at 25° C., as determined by a compression test with a load cell of 100N and parallel plates, at a test speed of 90 mm/min, with a strain percentage set to 50%; or
a compression strength of at least 10 KPa at 50° C., as determined by a compression test with a load cell of 100N and parallel plates, at a test speed of 90 mm/min, with a strain percentage set to 50%.

73. The edible lipid element of claim 64, characterized by any one of:
storage modulus at 25° C. of between about 1 KPa and about 10 KPa as determined by shear rheometer using a temperature Sweep Test 5° C.-90° C., on a disc specimen of said lipid element having a diameter of 40 mm and thickness of 1 mm, using 40 mm stainless steel, sandblasted parallel plates, strain of 0.6%, and frequency of 10 Hz; or
storage modulus at 50° C. of between about 0.05 KPa and about 10 KPa as determined by shear rheometer using a temperature Sweep Test 5° C.-90° C. on a disc specimen of said lipid element having a diameter of 40 mm and thickness of 1 mm, using 40 mm stainless steel, sandblasted parallel plates, strain of 0.6%, and frequency of 10 Hz.

74. A food product, comprising:
one or more lipid elements as defined in claim 64, and being in a form of a multilayer product, at least some of the layers or at least some portions of some layers comprising said lipid element and at least one protein containing component.

75. The food product of claim 74, wherein the one or more lipid elements and the at least one protein containing component are discrete components within the product.

76. The food product of claim 74, wherein said lipid element therein, once isolated from the food product, is characterized by juiciness of at least 50% as determined using an equation:
$$\frac{Weight before - Weight after}{Weight before} = \% Juiceness$$
wherein said weight before is a weight of a disc sample of said isolated lipid element before applying a compression test, and said weight after is weight of said disc sample after applying said compression test.

77. A method of producing a lipid element, the method comprising:
mixing lipid material that is solid or semi solid at least at a temperature of 10° C., with a hydrocolloid forming aqueous solution comprising a hydrocolloid forming agent to form a mixture;
wherein, said mixing is at a temperature by which said lipid material is solid or semi solid; and
wherein said mixing provides a continuous hydrocolloid matrix having dispersed therein said lipid material.

78. The method of claim 77, wherein said lipid material is mixed in powder form, with said hydrocolloid forming aqueous solution.

79. The method of claim 77, further comprising mixing into said hydrocolloid mixture a cross linking aqueous solution comprising a cross linking agent and providing the mixture including the cross-linking agent a curing time sufficient to cause cross linking of the hydrocolloid forming agent with said cross linking agent or to allow gelation of said hydrocolloid forming agent.

80. The method of claim 77, wherein said lipid material comprises one or more edible lipids, with a weight ratio between the hydrocolloid forming agent and the one or more edible lipids of between about 1:1 and about 1:10.

81. The method of claim 77 wherein said mixing comprises co-extrusion of the mixture and said cross linking aqueous solution.

82. A method of producing a whole cut meat analogue, the method comprising:
dispensing a plurality of layers, stacked on top of another, each layer comprising essentially aligned protein strands, wherein at least part of the plurality of layers includes intermittently dispensed lipid element of claim 64, said lipid element being dispensed according to a predefined pattern.

83. A method of producing an alternative meat product, the method comprising:
mixing protein containing component with a lipid element of claim 64, wherein said protein mass and said lipid element are in particulate form, to allow the lipid element to be dispensed within the protein containing component.
